(19) United States
(12) Patent Application Publication
(10) Pub. No.: US 2010/0265451 A1
(43) Pub. Date: Oct. 21, 2010

(54) LIQUID CRYSTAL DISPLAY

(76) Inventor: Stephen Kitson, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/746,999

(22) PCT Filed: Dec. 21, 2007
(86) PCT No.: PCT/EP07/64460

§ 371 Date: Jun. 9, 2010

(51) Int. Cl. G02F 1/1333

(52) U.S. Cl. 349/160

(57) ABSTRACT

A liquid crystal display cell comprises first (1) and second (2) opposed cell walls enclosing a liquid crystal material (6) having an anisotropic absorber therein, and a microstructure (4) on an inner surface of the first cell wall (1). The microstructure (4) is formed from a material which has a refractive index that is more closely matched to the ordinary refractive index (nₒ) of the liquid crystal material than to the extraordinary refractive index (nₑ).

The present invention relates to liquid crystal displays.

Current display technologies do not use light very efficiently, so they usually incorporate a very bright backlight. Making a full colour reflective display that is easily viewable in ambient lighting conditions is a significant challenge, and as yet there is no clear solution.

One candidate technology is to use a liquid crystal (‘LC’) doped with anisotropic absorbers (a so-called ‘Guest-Host’ device). The ‘guest’ absorbers are usually rod-shaped or lath-shaped dye molecules that tend to align with the common alignment direction of the ‘host’ LC molecules, known as the director. They tend to absorb light polarised parallel to the molecular long axis. Therefore when they, and the LC, are aligned end-on to the viewer, they do not absorb and the display appears light. When the dyes and LC align side-on to the viewer they absorb one linear polarisation strongly and the display looks coloured. In order to achieve a high contrast ratio the display should be designed to absorb any polarisation of light in the dark state. There are a number of standard device configurations that achieve this; for example the Cole-Kashnow cell in which the dyed LC switches from vertical to planar alignment and which has a quarter waveplate between the cell and a reflector. The waveplate is oriented with its optic axis at 45 degrees to the planar alignment direction of the LC. Unpolarised light incident on the display passes through the cell and the waveplate, reflects and passes back through the layers to the viewer. One linear polarisation of the incident light is absorbed on the first pass through the cell, so that light with the orthogonal linear polarisation emerges from the cell, passes through the quarter wave plate and reflects from the mirror. The returning light that reaches the dye doped layer has a polarisation that has been rotated by 90 degrees so that it is now strongly absorbed before reaching the viewer.

Full colour displays have been produced, in which three Guest Host displays are stacked on top of each other, each doped with a different colour dye: cyan, yellow or magenta. This arrangement is more efficient than the alternative of arranging separate colour displays side by side.

The LC molecules, and the dye dissolved in them, are not perfectly ordered, which tends to reduce the difference between the two states. Ultimately it is hard to achieve the necessary contrast and brightness needed for an efficient reflective display.

Attempts have been made to improve the performance of guest host displays by increasing the dichroic ratio, which is a measure of the ordering of the dye molecules in the LC. The dichroic ratio (DR) is defined as

DR=A_{|}/A₊=(1+2S)/(1−S).

A_{|} and A₊ are the absorbances parallel to and perpendicular to the LC director, respectively, and S is the order parameter.

The maximum dichroic ratio typically achieved with nematic LC hosts is about 13.

Another attempt is to use a two-frequency LC material in a polymer gel, to combine absorption and scattering in the dark state, as described in Mol. Cryst. Liq, Cryst., Vol. 453, pp 371-378, 2006. Two-frequency LC materials exhibit positive dielectric anisotropy in an electric field in a first frequency range, and negative dielectric anisotropy in an electric field in a second, different, frequency range. The polymer gel is formed in situ from monomer dissolved in the dyed LC while the LC is aligned perpendicular to the cell walls by a low frequency field. In the OFF-state the LC molecules are aligned perpendicular to the cell walls and cell transmits light. When a high frequency field is applied, the LC molecules exhibit negative dielectric anisotropy and tilt away from the field direction, causing light scattering because of LC domain reorientations and refractive index mismatch, and light absorption by the dye molecules. The scattering further reduces the reflection in the dark state, increasing the contrast ratio of the display. All wavelengths are scattered, which is acceptable for monochrome displays but is a problem in a stacked colour device. Too much scattering reduces the amount of light reaching subsequent layers.

### SUMMARY OF THE INVENTION

Aspects of the invention are specified in the independent claims. Preferred features are specified in the dependent claims.

The anisotropy of LCs causes light polarised along the director to propagate at a different velocity than light polarised perpendicular to it. Hence, LCs are birefringent. A uniaxial LC, for example a nematic LC, has two principal refractive indices: the ordinary refractive index nₒ and the extraordinary refractive index nₑ. The index nₒ is measured for a light wave where the electric vector vibrates perpendicular to the optic axis (ordinary wave). The index nₑ is measured for a light wave where the electric vector vibrates along the optic axis (extraordinary wave). For an achiral aligned nematic LC, the optic axis is equivalent to the director.

By matching the refractive index of the microstructure to nₒ, diffraction and scattering of incident light through the cell wall that carries the microstructure will be reduced or minimised when the display is in its light state, with the director normal to the plane of the cell walls. In the dark state, with the LC aligned parallel to the plane of the cell walls, there will be an index mis-match that causes light to be scattered sideways where it is more strongly absorbed. This increases the difference in the reflectivity between the two states, improving the appearance of the display.

Typically the display will be used in reflective mode However, the display could also be used in transmissive mode.

The microstructure may comprise any suitable structures: for example a grating or an array of posts or holes. By controlling the length scale and shape of the units comprising the microstructure, the degree and direction of light scattering can be controlled.

The term “anisotropic absorber” is used herein to refer to a pleochroic dye dissolved in the LC or a pleochroic pigment dispersed in the LC. For convenience the invention will be described herein with reference to the used of a dissolved pleochroic dye, notably a dichroic dye, suitable examples of which will be well known to those skilled in the art of LC display technology.

### BRIEF DESCRIPTION OF THE DRAWINGS

The invention will now be further described, by way of example only, with reference to the following drawings in which:

FIG. 1 is a schematic view of a liquid crystal display cell in accordance with an embodiment of the invention with the liquid crystal in one orientation; and

FIGS. 2 and 3 are schematic views of the display cell of FIG. 1 with the liquid crystal in a different orientation.

### DETAILED DESCRIPTION

The display comprises a first cell wall 1 and an opposed second cell wall 2 enclosing a layer 5 of a liquid crystal material having a dissolved dichroic dye therein. On an inner surface of the first cell wall 1 there is provided a microstructure 4, in this example a grating structure in which the grooves are aligned into the page. The microstructure 4 is made from a material that has the same refractive index as nₒ of the LC material.

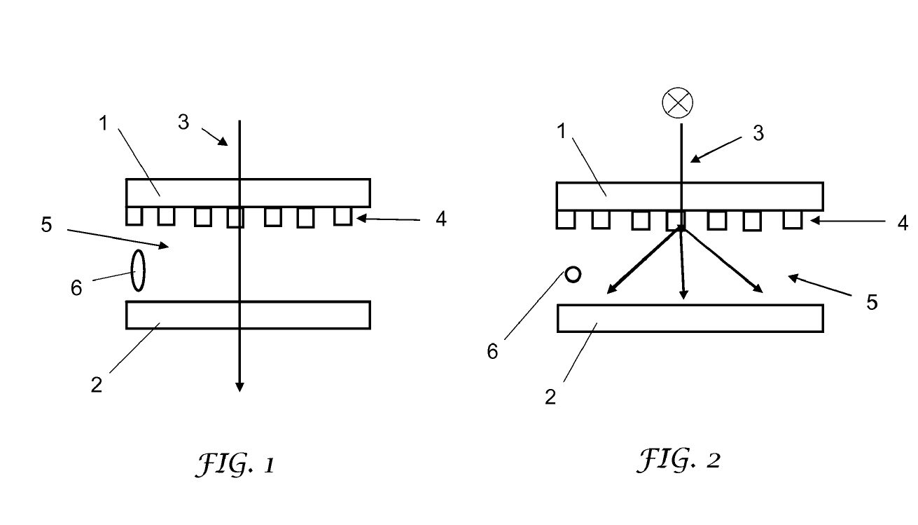

When molecules 6 of the LC material are aligned normal to the plane of the cell walls (FIG. 1) the index matching prevents or reduces any scattering or diffraction and incident light 3 propagates straight through the layer 5. The dichroic dye molecules are aligned with the LC molecules 5 and do not strongly absorb the light 3. The cell is therefore in a light state.

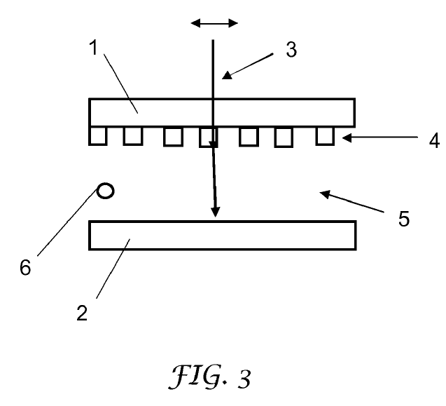

When LC molecules 6 are aligned horizontally, along the grooves of the grating the index mis-match at the surface of the microstructure 4 results in strong diffraction and scattering of the light 3 that is polarised in a direction into the page (FIG. 2). The diffracted or scattered beams take a longer path through the cell, increasing the interaction with the absorbing dye. In this arrangement the cell is in a dark state.

The arrangement shown in FIG. 3 is the same as for FIG. 2 except that the incoming light is polarised across the grooves of the grating 4. There is no index mis-match and no diffraction.

The LC molecules 6 may be made to align either vertically or horizontally by conventional techniques such as treating a surface with a rubbed polymer (to induce parallel alignment) or with a surfactant such as lecithin or a chrome complex (to induce vertical alignment). Switching from parallel alignment to vertical alignment may be achieved for a liquid crystal of positive dielectric anisotropy by applying a suitable electric field via transparent electrodes (not shown). Switching from vertical alignment to parallel alignment may also be achieved for a liquid crystal material of negative dielectric anisotropy by applying a suitable electric field. Such alignment and switching techniques are of course well known in the art and need no further description.

An advantage of the invention is that the angle of scatter can be controlled through engineering of the pitch of the microstructure 4. The amount of light that gets scattered into the higher angle beams depends on the shape of the microstructure. In one embodiment the microstructure is partly or wholly randomised, for example as a random or pseudorandom grating or a two dimensional array of posts or holes, to optimise or refine the scattering properties of the microstructure. Previous work suggests that diffracting about 30% of the light is readily achievable. Theoretical consideration of the optics would suggest that it ought to be possible to scatter much more light into those beams through appropriate design.

The increase in path length achieved depends on diffraction angle, which scales inversely as the cosine of the angle. Thus, for example, a diffraction angle of 30° increases the path length by 15% over a ray at normal incidence to the cell walls. However, if the diffraction angle is greater than a critical angle then the diffracted light will not escape from the display but will instead be reflected internally. For typical refractive indices the critical angle will be about 42° from the normal to the cell walls. If one can achieve that angle then the diffracted light will ultimately be lost from the viewer, reducing the reflectivity (or transmissivity) of the darker state. Making a conservative estimate that 30% of the incident light 3 goes into the diffracted beam then the contrast ratio could be effectively increased by this amount.

The equation that determines the angle of the diffracted beam, for the simplified case of light at normal incidence, is given below.

$${λ}_{g} = \pm \frac{m {λ}_{0}}{n sin {θ}^{m}}$$

λ_{g} is the pitch
λ₀ is the wavelength
θ^{m} is the diffraction angle for the m^{th} diffracted order
n is the refractive index

The angle depends on the wavelength of the light and the pitch of the microstructure. Applying the above equation, it is found that in order to diffract the light at an angle just greater than the critical angle, one needs a pitch that is close to the wavelength. That wavelength selectivity may be useful. In each layer, one only wants to diffract the wavelengths that will be absorbed by the dye in that layer. The other wavelengths need to escape to the next layer. For a given pitch, longer wavelengths will be diffracted at a smaller angle. Therefore it may be advantageous to order the layers so that the layer with the dye that absorbs the longest wavelengths is first, with the layer that absorbs the shortest wavelengths last. By tuning the pitch of the microstructure in each layer it should be possible to minimise the amount of loss of the “wrong” wavelengths in each layer. It may be desirable to include another microstructure on the inner surface of the second cell wall to scatter unabsorbed light out of the layer.

One design choice is the type of microstructure. A simple array of parallel grooves (a monograting) is preferred. It has the advantage that the LC molecules tend to align along the grooves which is the right direction for index mis-matching However, there may be advantages to more complex 2D arrays of posts, holes, pillars etc. They may tend to scatter light in all directions within the layer, which may be helpful in dealing with light incident from all directions. It is worth noting that the diffraction angle does depend on the incident angle of the light. The simple analysis above assumes that the light is incident normal to the display. In reality it is more likely that the majority of the illumination comes from a preferred direction—typically from overhead the viewer. It may therefore be preferable to tune the design to work best with a narrow range of incident angles centred around a given direction.

Preferred microstructures have pitches in the range of about 400-600 nm. It is possible to make monogratings over large areas using diamond point turned rollers. It is also possible to make more complex microstructures over large areas using alternative techniques known to those skilled in the art, and which may be used to align LCs. Having obtained a surface coated with the microstructure it is possible then to replicate that structure many times using an imprinting process. We have used such a process to test the effect of using a long pitch (1200 nm) monograting in a guest host cell. The polymer that we typically use is a UV-curable acrylate resin which is formulated from standard commercially available components and has a refractive index that is close to the ordinary index of the LC used. In operation we can see that when the LC is aligned parallel to the surface the diffraction is strong. By applying a voltage we can make the LC align vertically, and the diffraction is much weaker.

### Experimental Details

The microstructure was formed by imprinting from a monograting master: 1.2 μm pitch: approx. 1 μm high. Imprinting was carried out on an ITO-coated PES substrate, which functioned as the first cell wall 1. The cell wall 1 was made into a test cell with a second cell wall 2 coated with a rubbed polyimide (SE-130, Nissan Chemicals). The cell walls were spaced apart by 3 μm beads dispersed over the surfaces and the cell was filled with ZLI-4727 nematic LC mixture (Merck).

With no voltage applied, the LC is planar and there is strong diffraction of light which is polarised along the grating grooves. An applied voltage (1 kHz AC, 30 V amplitude) drives the LC to a vertical alignment and the diffraction is very weak. With a monograting, only one polarisation of light is diffracted strongly. The other polarisation (across the grooves) sees no difference in refractive index. In order to absorb both polarisations one may use a configuration such as the Cole-Kashnow cell discussed earlier.

With more complex structures, such as posts, the dependence on polarisation is more complex.

The invention allows control over the direction and intensity of the scattered light, allowing scattering in undesired directions to be reduced and help improve optical efficiency.

Microstructures can also align LCs very effectively, so it may be possible to use the one structure both to align the LC and control the optics. It may even be possible to use the structure to enable bistable alignment of the LC.

1. A liquid crystal display cell comprising first and second opposed cell walls enclosing a liquid crystal material having an anisotropic absorber therein, and a microstructure on an inner surface of the first cell wall; wherein the microstructure is formed from a material which has a refractive index that is more closely matched to the ordinary refractive index (nₒ) of the liquid crystal material than to the extraordinary refractive index (nₑ).

2. A display cell according to claim 1, wherein the refractive index of the microstructure material is in the range nₒ±5%.

3. A display cell according to claim 1, wherein the refractive index of the microstructure material is substantially equal to nₒ.

4. A display cell according to any preceding claim, wherein the microstructure is a grating.

5. A display cell according to any of claims 1-3, wherein the microstructure is an array of posts.

6. A display cell according to any of claims 1-3, wherein the microstructure is an array of holes.

7. A display cell according to any preceding claim, wherein the microstructure has a pitch in the range 300-1000 nm.

8. A display cell according to any preceding claim, wherein the microstructure has a pitch in the range 400-600 nm.

9. A display cell according to any preceding claim, wherein the microstructure induces a uniform alignment of adjacent molecules of the LC material.

10. A display cell according to claim 9, wherein the alignment is a planar or tilted planar alignment.

11. A display cell according to any preceding claim, wherein the mismatch in refractive index between the microstructure and nₑ of the liquid crystal material is such as to induce at least some incident light to be totally internally reflected between the cell walls.

12. A display cell according to any preceding claim, wherein the microstructure comprises features in a random or pseudorandom array.

13. A display cell according to any preceding claim, further comprising a second microstructure provided on an inner surface of the second cell wall; said microstructure being formed from a material which has a refractive index that is more closely matched to the ordinary refractive index (nₒ) of the liquid crystal material than to the extraordinary refractive index (nₑ).

14. A display cell according to claim 13, wherein the refractive index of the second microstructure material is in the range nₒ±5%.

15. A display cell according to claim 13, wherein the refractive index of the second microstructure material is substantially equal to nₒ.

16. A display cell according to any of claims 13-15, wherein the second microstructure is a grating.

17. A display cell according to any of claims 13-15, wherein the second microstructure is an array of posts.

18. A display cell according to any of claims 13-15, wherein the second microstructure is an array of holes.

19. A display cell according to any of claims 13-18, wherein the second microstructure has a pitch in the range 300-1000 nm.

20. A display cell according to any of claims 13-19, wherein the second microstructure has a pitch in the range 400-600 nm.

21. A display cell according to any of claims 13-20, wherein the second microstructure induces a uniform alignment of adjacent molecules of the LC material.

22. A display cell according to claim 21, wherein the alignment is a planar or tilted planar alignment.

23. A display cell according to any of claims 13-22, wherein the second microstructure comprises features in a random or pseudorandom array.

24. A display device comprising at least two display cells according to any preceding claim, stacked one on top of another; the dye in each cell being capable of absorbing light in a wavelength range substantially different from the dye in the or each other cell.

25. A display device according to claim 25, comprising three display cells each of which is capable of selectively absorbing a different one of cyan, yellow and magenta.

26. A display device according to claim 25, further comprising a reflector behind an end one of the cells.

27. A display device according to claim 26, wherein the cell closest to the reflector is capable of absorbing yellow wavelengths, the middle cell is capable of absorbing green wavelengths, and the cell farthest from the reflector is capable of absorbing red wavelengths.

28. A display device according to any of claims 24-27, wherein each of the cells has a different pitch of microstructure to the other cells.

29. A display cell or display device substantially as herein described with reference to the drawings.
